(19) United States
(12) Patent Application Publication
(10) Pub. No.: US 2008/0030730 A1
(43) Pub. Date: Feb. 7, 2008

(54) Water contamination measurement apparatus

(75) Inventors: Robert Clark, Cincinnati, OH (US); Pratim Biswas, Chesterfield, MO (US); Virendra Sethi, Mumbai (IN); Roy C. Haught, Independence, KY (US)

Correspondence Address: BACON & THOMAS, PLLC, 625 SLATERS LANE, FOURTH FLOOR, ALEXANDRIA, VA, 22314, US

(73) Assignee: The United States of America as represented by the United States Environmental Protection Agency, Washington, DC (US)

(21) Appl. No.: 11/498,063

(22) Filed: Aug. 3, 2006

(51) Int. Cl. G01N 21/00

(52) U.S. Cl. 356/338; 356/343

(57) ABSTRACT

An apparatus for measuring the impurity content of drinking water processes has a monochromatic light source projecting a beam of visible light toward a light trap. A water sample generator passes a water sample transverse to and intersecting the beam of light. A photo sensor array with an angular resolution of at least 0.10° detects forward scattered light from particles in the water sample. A data acquisition and processing system connected to the photo sensor array receives signals of the intensity of scattered light as a function of the scattering angle and compares the received light intensities to stored patterns of known waterborne contaminants. Based upon detected contaminants and their concentrations, the data acquisition and processing system provides an output on a connector which can be used to control a water processing system to adjust treatment of drinking water for contamination such as bacterial pathogens.

### BACKGROUND OF THE INVENTION

This invention relates to apparatus for measuring the contamination level of drinking water.

Recent events have spotlighted the susceptibility of water and food supplies to contamination by pathogens, and have focused public attention on the need for quick and accurate detection of such disease-causing microorganisms.

According to the Centers for Disease Control, food borne Escherichia coli causes an estimated 73,000 cases of infection and 61 deaths in the United States each year (CDC, 2001). Major sources of contamination occur in ground beef. Other sources include consumption of unpasteurized milk and juice, sprouts, lettuce, and salami, and contact with cattle. Transmission also occurs through water: swimming in contaminated lakes, and pools, or drinking inadequately chlorinated water.

Another deadly pathogen, Cryptosporidium, has caused great alarm because of recent contaminations in drinking water and beverages. A notable Cryptosporidium outbreak occurred in the spring of 1993 in Milwaukee, Wis., where a contaminated municipal drinking water supply resulted in an estimated 400,000 cases of acute gastroenteritis and over 100 individuals (mostly with compromised immune systems) died.

The threat of waterbome pathogens has spread worldwide. In 1998, more than 3.8 million residents in Sydney, Australia were ordered to boil drinking water due to unacceptably high levels of Cryptosporidium and Giardia in the water supply. In addition to known outbreaks, many other instances of disease associated with contamination of the water and food supplies likely occur, but are either unrecognized or unreported.

Real time detection of these pathogens is increasingly important, especially in the wake of outbreaks such as those described above. In the Milwaukee case, for example, two weeks passed before sample-testing methods that were currently being employed conclusively detected Cryptosporidium in the water supply. It is likely that increased speed of testing may have saved lives. Currently, detection, identification, and process control of bacteria and pathogens for drinking water systems utilize microbiological and physical testing methods. The methods include flow cytometry, chromatography, and indirect fluorescent antibody (WA), all of which are skill intensive and time consuming. In-line turbidity testing for water clarity or presence of cloudiness is also used; the presence of cloudiness is often an indicator of pathogen presence, signaling a potential need for drinking water treatment.

The purposes of the EPA Interim Enhanced Surface Water Treatment Rule (IESWTR), and both stages of the Long-term Enhanced Surface Water Treatment Rule (LTESWTR) are to enhance protection from microbial pathogens, including Cryptosporidium in drinking water, and address risk trade-offs with disinfection byproducts. Building on the treatment technique requirements of the Surface Water Treatment Rule (SWTR), the emphasis on increased monitoring and more specific detection of the protozoan Cryptosporidium and other hard to detect microbial pathogens, as well as tightened turbidity monitoring, creates a need for technology that enables drinking water facilities and treatment plants to effectively comply with these requirements.

Current methods for monitoring of pathogens rely on sample-based testing at certified drinking water laboratories to detect and to identify pathogenic problems. These methods, according to a recent AWWA report (Allen, Clancy, and Rice, 2000), are plagued with problems regarding poor sensitivity, reproducibility and high detection limit (>100 organisms/L).

The existing water purity measurement devices can be grouped under the general term multiple angle light scattering (MALS) measurement devices. At least four commonly known devices exist within this class. The class includes turbidimeters, particle counters, light scattering measurement devices, and cytometers.

“Light scattering measurement device” is a term that describes a variety of multiple angle light scattering devices. Light scattering measurement devices are instruments that measure the intensity of light scattered at one or more angles as a beam of light passes through a liquid medium. The light scattering measurements are reported as an intensity value as a function of the angle between the measurement sensor and the source of the beam. Light scattering measurement devices have a variety of configurations.

“Particle counters” or “optical particle counters” are instruments that estimate the size of suspended impurities in the liquid medium. Particle counters count and size individual particles as the particles enter the aperture of the detection system. Particle counters may provide a wide range of measurement data, including particle size distribution or average particle size.

“Cytometers” are instruments that measure the intensity of scattered light at two different angles. The first sensor is usually positioned at an angle of 90° to 180° between the light source and the sensor. The second sensor is usually positioned at an angle of 90° between the light source and the sensor. The cytometer calculates the ratio of the intensity and compares the measurement to known standards to characterize the impurity content of the liquid medium.

“Turbidimeters” are instruments that measure the intensity of light scattered by a liquid medium at one specific angle. The specific angle is determined by the particular turbidimeter standards that apply for an expected range of turbidity for the liquid medium. The light intensity measurements provide an indication of the particulate content of the liquid. However, the intensity measurements only provide an estimate of the volume fraction of the impurities and do not provide an estimate of the size, shape, or other characteristics of the impurities. Turbidimeters have fewer configurations than the other three devices listed above and, may be subject to specific standards.

The prior art contains apparatus for detecting microorganisms in fluids or water but these prior art apparatus generally have one or more deficiencies which render these apparatus unsuitable for use in providing timely information that could be used for controlling water purification. These deficiencies include the inability to provide real time detection of pathogens, the inability to distinguish the presence of particular microorganisms from other contaminants, the requirement to detect fluorescence thus adding to the complexity and susceptibility of the apparatus for failure, poor reproducibility, poor sensitivity, and requirements for high detection limits (>100 organisms/L), etc.

One object of the present invention is an improved apparatus for determining water purity to help satisfy the continuing need of municipalities, government agencies, and industry to control the contaminant content of drinking water.

Another object of the invention is provide a water purity measurement apparatus can be used as a component in a process control system that adjusts the water treatment process.

One feature of the present invention is the ability to obtain all of the traditional water quality measurements simultaneously: turbidity measurements; light scattering intensity measurements; cytometer measurements; and particle counting measurements.

Another feature is the ability to take measurements in a near real-time mode.

A third feature is the ability to make sufficiently high resolution measurements to allow the process control system to identify the concentration of specific contaminants based upon the signature shape of the contaminants without the use of fluorescence.

### BRIEF SUMMARY OF THE INVENTION

The invention is summarized in an apparatus for measuring the impurity content of drinking water processes wherein a monochromatic light source projects a beam of visible light toward a light trap. A water sample generator passes a water sample transverse to and intersecting the beam of light. A photo sensor array with an angular resolution of at least 0.10° detects forward scattered light from particles in the water sample. A data acquisition and processing system connected to the photo sensor array receives signals of the intensity of scattered light as a function of the scattering angle and compares the received light intensities to stored patterns of known waterborne contaminants. Based upon detected contaminants and their concentrations, the data acquisition and processing system provides an output on a connector which can be used by operators to control a water processing system to adjust treatment of drinking water for contamination such as bacterial pathogens.

The subject technology consists of a high resolution MALS device providing the capability to specifically identify and quantify very small particles in drinking water, bottled water, beverages, milk or food. A liquid or suspension of the subject matter flows through a sensing zone, which is a focused beam of visible light, such as a laser. The light signal is influenced by the size, shape and structure of bacteria or pathogens. Unlike flow cytometry where only two angles of scattered light are detected, MALS technology can obtain light scattered from a range of angles. For example, a range of locations concentric to the sensing zone from 85 to 95 degrees at increments of 0.1 degree is possible using the subject technology.

The fluid suspension is passed through the sensing zone, thus intercepting the visible-range laser light. The laser light may be generated by low cost lasers, which are widely used in the barcode recognition systems today. Scattered laser light is recorded on photodiode detectors strategically located around the sensing zone. Each voltage value is stored in the system's memory. The results are digitized and can be represented in several forms, such as an isometric three-dimensional surface plot. The voltages may be stored as a pattern of intensities and compared with a known calibration standard providing specific identification. The voltages can be converted into standard output signals for turbidimeters, particle counters, cytometers, or multiple-angle light scattering measurement systems.

### BRIEF DESCRIPTION OF THE DRAWINGS

FIG. 1 is a block diagram with some parts shown in elevation of a water contamination measurement apparatus in accordance with the present invention.

FIG. 2 is a plan view of a portion of the water contamination measurement apparatus of FIG. 1

FIG. 3 is a flow chart of a procedure for generating and storing standards for determining identity and concentration of contaminants.

FIG. 4 is a flow chart of a procedure use in a data acquisition and processing system of the apparatus of FIGS. 1 and 2.

FIG. 5 is a graph illustrating relative sizes of organisms which can contaminate water.

FIG. 6 is a graph showing typical angular distribution of scattered light by several rod-shaped microorganisms.

FIG. 7 is a graph showing typical anglular distribution of scattered light by several spherical or ovoid microorganisms and particles.

FIG. 8 is flow chart of alternative procedure which can be employed in the data acquisition and processing system of FIGS. 1 and 2.

### DETAILED DESCRIPTION OF THE INVENTION

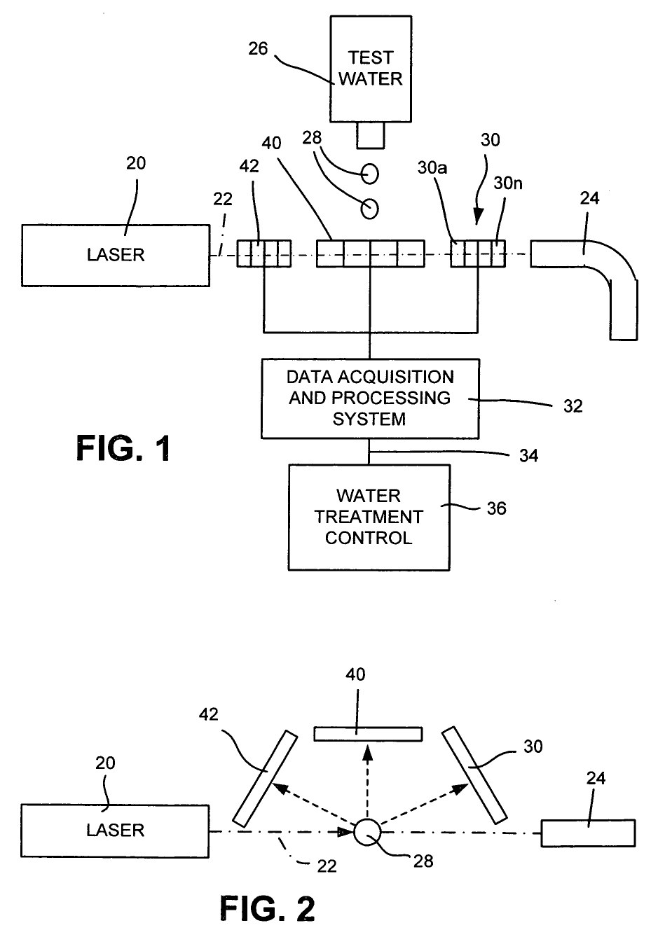

As shown in FIGS. 1 and 2, an apparatus suitable for use in a drinking water purity detection includes a monochromatic light source 20 for generating a beam of visible light 22, a light trap 24 mounted opposite the light source to receive and trap non-diverted portions of the beam of visible light, a water sample generating device 26 for generating water samples 28 and passing the water samples perpendicular to and intersecting the beam of light, a photo sensor array 30 mounted so as to receive forward scattered light (light scattered at an angle less than ninety degrees by particles in the water sample), a data acquisition and processing system 32 connected to the photo sensor array 30 for obtaining intensity measurements of sensed scattered light as a function of angular position from the light beam 22 and for comparing the obtained intensity measurements to stored scatter patterns of known water borne contaminants, and a connector 34 for providing an output signal for use in controlling a water purification process such as employed in a water treatment control 36. The photosensor array includes a plurality of sensors 30a to 30n spaced so as to provide a sensing resolution of at least 0.1′, i.e., the difference in scattering angles of sensed scattered light of adjacent sensors of the array is 0.1′ or less. This resolution enables improved sensing of known microorganisms which sometimes contaminate drinking water.

Additionally second and third light sensors 40 and 42 can be provided. The light sensor 40 detects light scattered at an angle of about 90° while the sensor 42 detects back scattered light, i.e., light scattered at an angle greater that 90°. These sensors 40 and 42 can be photosensor arrays similar to the photosensor array 30.

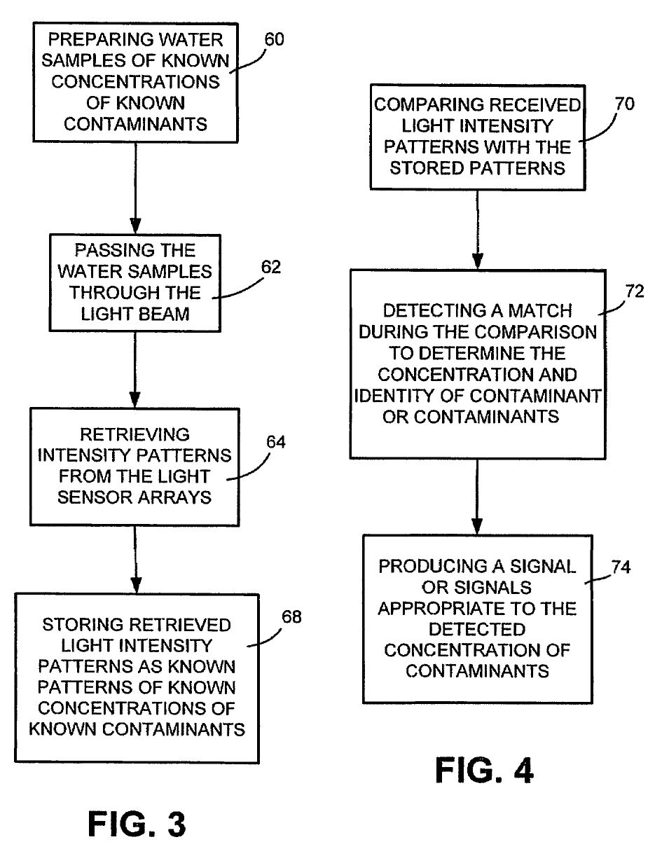

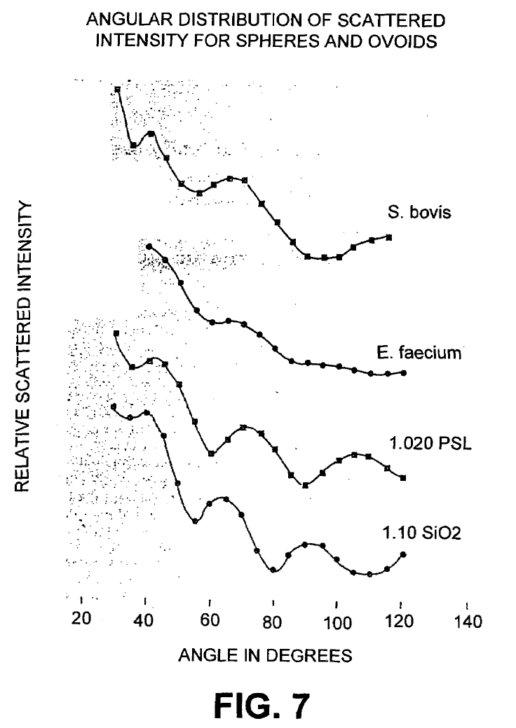

The data acquisition and processing system 32 includes stored light intensity patterns of known concentrations of known contaminants. These light intensity patterns can be prepared and stored in the system 32 by the procedure of FIG. 3. Initially water samples of known concentrations of known contaminants are prepared in step 60. Then these water samples are passed through the light beam 22 in step 62. In step 64 as each water sample is passed through the light beam in step 62, the light intensity patterns are retrieved from the light sensor arrays 30, 40 and 42. Finally in step 66, the retrieved light intensity patterns are stored in the data acquisition and processing system 32 as known patterns of known concentrations of known contaminants. FIG. 6 illustrates typical light intensity patterns for rod-shaped microorganisms B. subtilis, E. coli and E. cloacae. FIG. 7 illustrates typical light intensity patterns for spherical and ovoid microorganisms S. bovis and E. faecium as well as for particles PSL and S′02

The selection of a water sample generating source 26 is also not critical. Any commercially available droplet production source should be sufficient, if the droplets are of sufficient size to provide statistically significant measurements and the instrumentation has been properly calibrated. A sample vial or tube may also be substituted for a droplet production source. The vial or tube should be designed so that a continuous stream of liquid can flow in and out of the vial or tube. The vial or tube may also be designed so that the sample can be maintained as a static fluid.

The selection of the light trap 24 is not critical. The light trap may be any commercially available suitable device or an equivalent device receiving and absorbing light to prevent non-scattered light from the light beam 22 from reaching the sensor array 30

The selection of the three photo sensor arrays 30, 40 and 42 is critical. The first photo sensor array 30 must have a sufficient number of segments to discriminate intensity measurements as a function of angular position at increments of 0.10° or less. In one embodiment the sensor array 30 is a commercial linear sensor device having 1024 elements with an aspect ratio of 100:1.

The second sensor 40 and the third sensor 42 may be identical to the first sensor. The sensors 40 and 42 can be selected from any commercially available sensor capable of taking at least one light intensity measurement. Alternatively, the sensors 30, 40 and 42 can be components of a sensor array which may or may not include a combination of the first sensor array 30, the second sensor 40, and/or the third sensor 42.

The selection of a data acquisition and processing system 32 is also not critical. The data acquisition 32 must be sufficiently fast to obtain and process at least a sufficient number of intensity measurements from the forward sensor array 30 at a rate that will provide near-real time measurements. In one embodiment the data acquisition and processing system comprises a 16 bit, 100 k. Hz analog-to-digital converter data acquisition board connected to a computer system, which will take the measurements and provide output to the water treatment facility through the connector 34. The system 32 includes a program with the procedure shown in FIG. 4 having step 70 wherein the light intensity measurements forming a light intensity pattern are compared to the stored patterns of light intensity of known concentrations of known particles or microorganisms. A match found during the comparison results in the identification of a contaminant or contaminants in step 72. In step 74 the data acquisition and processing system produces any signal or signal on the connector 34 appropriate for a detected concentration of contaminants when it is necessary to adjust the water treatment control 36.

The type of connector 34 is also not critical. The connector connects the water treatment system 36 to the data acquisition and processing system 32. The water treatment system must be able to accept output from the data acquisition system, and change the water treatment conditions accordingly.

The operation of the system begins with the operation of the water sample generator 26 producing a water sample, such as a stream of droplets 28, a continuous water stream (not shown) or vials (not shown), suitable for measuring contaminants in the water source. The sample passes between the light source 20 and the light trap 24. A beam of light 22 from the light source 20 passes through the sample 28 from the light source to the light trap 24. Depending upon contaminants in the sample, the beam of light is scattered into the sensor arrays 30, 40 and 42. The light trap absorbs the light which is not reflected or refracted. The light strikes the sensors causing the sensors to convert the light into an electrical signal.

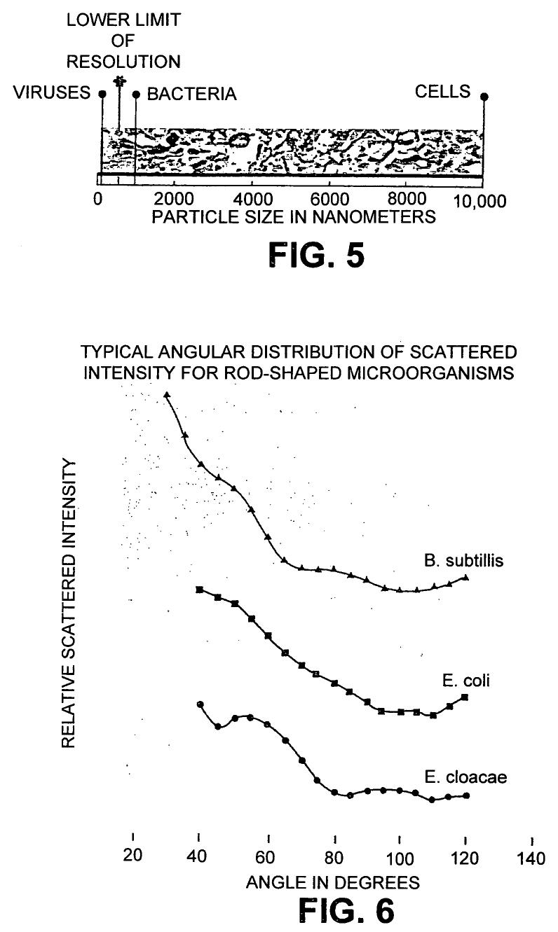

As shown in FIG. 5, the present system can detect and sense microorganisms as small as bacteria or about a diameter equal to the wavelength of the light source 20.

The data acquisition system reads the voltages from the sensor arrays and stores the values of the voltages in its memory as an intensity patterns of the sample. The stored pattern of intensities is compared to the stored intensity patterns of a known calibration standards. The voltages may also be converted into the standard output signals for turbidimeters, particle counters, cytometers, or multi-angle light scattering measurement systems.

In the particle counter mode, the light source strikes the droplet and is scattered into the forward sensor array 30. The intensity of the light is measured at various angles and the measurements are collected by the data acquisition system 32. The pattern of light intensity as measured at various angles is compared to calibrated patterns for specific contaminants and pathogens. By comparing the patterns, the data acquisition system 32 can identify the contaminant. The data acquisition system can then provide that data to the water treatment system through the connector. The water treatment system can adjust the treatment process to eliminate or reduce the concentration of the contaminant.

In the turbidimeter mode, the light source strikes the droplet and is scattered into the forward sensor array 30. The intensity is measured by the sensors in the array and then sent to the data acquisition system. The intensity of the light that strikes the sensor array may be summed over the entire range of the array. The intensity may also be summed over specific ranges that conform to certain turbidimeter standards. The intensity should correspond to specific contaminant concentration ranges. The data may be used to adjust the water treatment process. The use of the forward sensor array allows turbidity measurements at low levels of turbidity.

The system may also operate as a turbidimeter by collecting intensity measurements at different angles. By collecting data at an angle perpendicular to the path of the light source, the system corresponds to the standard imposed by ISO. By collecting back scattered light, i.e., light reflected at angles greater than 90°, the system can collect data in high turbidity conditions.

In the cytometer mode the droplet generator 26 generates a droplet 28. Light from the light source passes through the droplet. The light that passes through the droplet but is scattered at different angles represents the intensity distribution that is used to provide the desired information. The excess light is caught in the light trap 24. The light scattered at different angles strikes individual detectors. The detectors provide a voltage reading based upon the intensity of the light striking the detector. The voltage readings can be used to calculate the ratio of the intensity at one standard cytometer sensor position to the intensity at the other standard cytometer position. In such a manner, the output is identical to standard cytometer output.

In the multi-angle mode, the droplet generator 26 generates a droplet 28. Light from the light source passes through the droplet. The light that passes through the droplet but is directed at different angles via scattering represents the light that is used to provide the desired information. The excess light is caught in the light trap 24. The light that is scattered at different angles strikes individual detectors or sensors in the sensor arrays 30, 40 and 42. The detectors provide voltage readings based upon the intensity of the light striking the detectors. The voltage readings are measured by the data acquisition and processing system 32, so that the light intensity as a function of angle can be determined. The high resolution of the system (angle increments less than 0.1°) allows the determination of the identity of microorganisms in the sample.

The output of all four modes can be compared to known standards for known contaminants. This comparison allows the system to determine the concentration of known contaminants. The standards may be obtained by passing water contaminated with known concentrations of contaminants through the system and taking measurements of the contaminant level. The measurements may also be stored in the, memory of the data acquisition system and recalled at the calibration time. The output may take the form of one specific voltage to reflect the degree of contamination, a simple on/off voltage output to reflect acceptable or unacceptable levels of contamination, or in the form of multiple voltages to reflect the different measurements of the different modes of operation. The output signal may also be in digital or analog form.

In one embodiment a water droplet sample flows from a source into a vial. A HeNe laser generates a light beam with a wavelength of 632.8 nm. The light beam passes through the sample in the vial. When the sample contains contaminants, scattered light strikes the sensor array 30. Excess light is trapped in a light trap. In this embodiment, the sensor array 30 is a monolithic self scanning linear photo diode optimized for application in spectroscopy. The sensor array comprises 1024 elements with an aspect ratio of 100:1. Thus light beam intensity of forward scattered light is measured at a plurality of positions on the sensor array elements at angles less than 90° relative to the beam 22. Each sensor array element generates a voltage signal proportional to the intensity of light impinging on the element. The sensor array 40 generates at least one proportional voltage signal at a position perpendicular to the beam 22; this signal allows the apparatus to obtain a measurement that is equivalent to a turbidimeter measurement. The sensor array 42 generates a least one proportional voltage signal from back scattered light at an angle less than 90° from the beam 22; this signal allows the apparatus to obtain a measurement that is equivalent to a cytometer measurement. The data acquisition and processing system 32 converts the voltage measurements into digital signals and stores the measurements in a data structure with voltages stored in positions corresponding to angular positions. A processor within the system compares the voltages to voltages for known or stored standards that correspond to the concentration of contaminants or specific optical response patterns.

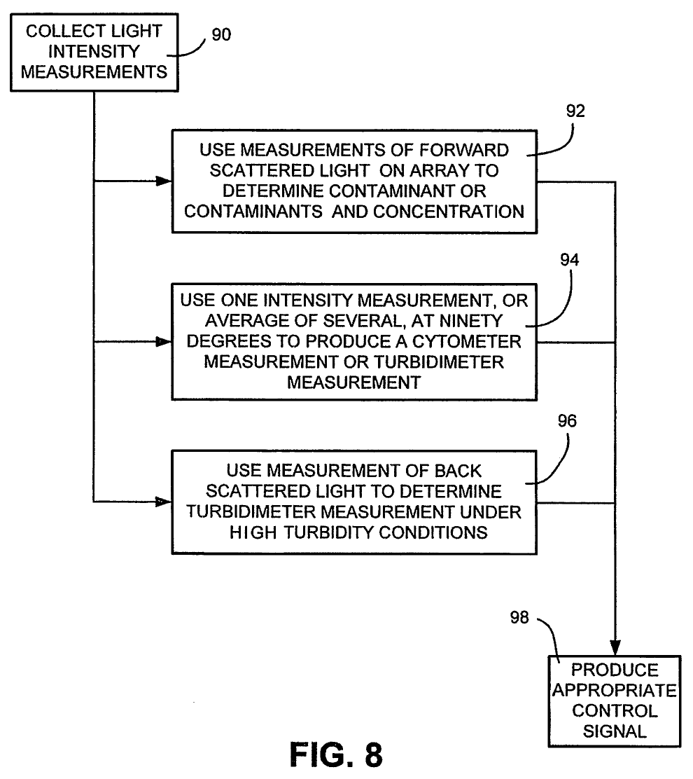

As shown in FIG. 8, the processor may also calculate turbidity or cytometry measurements from the incoming voltage data. After collecting the light intensity measurements from the sensor arrays in step 90, the data acquisition and processing system 32 can use the measurements of forward scattered light in step 92 to determine the identity of a contaminant and the concentration of the contaminant, use a measurement or average measurement of light intensity scattered at about 90°, and/or use one or more measurements of back scattered light in step 94 to produce a turbidimeter measurement under heavy turbidity conditions. Then in step 98 the system 32 generate a signal or signals that are appropriate for use in water treatment control. Thus, the system of the invention can be used to measure various properties of waste water as well as drinking water, to analyze the data, and to be used for making the appropriate adjustments in a waste water treatment process. The invention can be used to obtain near-real time turbidity, light scattering, and particle counting measurements, simultaneously. The invention can be used to obtain turbidity measurements in high turbidity and low turbidity conditions. Also, the invention does not require fluorescence to discriminate biological contaminants.

While the above description contains many specifics, these should not be construed as limitations on the scope of the inventions, but as an exemplification of one preferred embodiment thereof. Many other variations are possible. Accordingly, the scope of the invention should be determined not by the embodiments illustrated, but by the appended claims and their legal equivalents.

1. An apparatus suitable for use in a drinking water purification process comprising:
a monochromatic light source;
a light trap mounted opposite said monochromatic light source so that the beam from the monochromatic light source strikes the light trap;
a water sample generating device for generating a water sample and passing the water sample perpendicular to said monochromatic light source and said light trap so that the beam penetrates into and through the water sample;
a photo sensor array, said photo sensor array comprising a plurality of sensor elements for sensing light scattered by particles in the water sample with an angular resolution of at least 0.1 degrees;
a data acquisition and processing system connected to said photo sensor array for obtaining intensity measurements of scattered sensed light as a function of angular position from the photo sensor array and for comparing the obtained intensity measurements to known scatter patterns of waterborne contaminants; and
a connector for providing an output signal for use in controlling a water purification process.

2. The apparatus of claim 1 where said photo sensor array is mounted at an angle greater than 90 degrees between said light source and said droplet generator.

3. The apparatus of claim 2 further comprising:
a first sensor mounted perpendicular to said monochromatic light source and connected to said data acquisition and processing system; and
a second sensor mounted at an angle less than 90 degrees between said light source and connected to said data acquisition and processing system.

4. A method for measuring the contaminant content of drinking water comprising the steps of:
generating a water sample by using a water sample generating device;
measuring the intensity of light incident on a light sensor array, said light sensor array positioned at an angle greater than 90 degrees relative to said light source and said water sample generating device;
converting the intensity measurements into a voltage signal proportional to the light intensity measurements;
storing the voltage measurements in a data structure in which voltage measurements correspond to the angular position of individual light sensor elements;
comparing the voltage measurements with data structures of stored voltage measurements corresponding to known concentrations of contaminants; and
generating an output signal proportional to the concentrations of contaminants.

5. The method in accordance with claim 4 wherein said light sensor array has an angular resolution of at least 0.1 degrees.
